(19) United States
(12) Patent Application Publication
(10) Pub. No.: US 2010/0019486 A1
(43) Pub. Date: Jan. 28, 2010

(54) MUFFLER FOR AN EXHAUST SYSTEM

(76) Inventor: Erik Trefzger, Oberndorf (DE)

Correspondence Address: PAMELA A. KACHUR, 577 W Santee Drive, Greensburg, IN, 47240, US

(21) Appl. No.: 12/296,948

(22) PCT Filed: Apr. 3, 2007
(86) PCT No.: PCT/EP2007/003005

§ 371 Date: Aug. 4, 2009

(30) Foreign Application Priority Data
Apr. 13, 2006 (DE) 10 2006 017 812.2

(51) Int. Cl. F16L 39/00

(52) U.S. Cl. 285/124.3

(57) ABSTRACT

A muffler for an exhaust system of a combustion engine has a housing and at least one inlet pipe and at least one outlet pipe each having a pipe end arranged inside the housing. A common intermediate bottom is provided for holding the pipe ends on the housing.

### RELATED APPLICATIONS

The application is the U.S. National Phase of PCT/EP2007/003005 filed Apr. 3, 2007, which claimed priority to German Application 10 2006 017 812.2 filed Apr. 13, 2006.

### TECHNICAL FIELD

The invention relates to a muffler for an exhaust system of a combustion engine, in particular of a motor vehicle, having a housing and at least one inlet pipe and at least one outlet pipe each having a pipe end arranged inside the housing. Such mufflers are mounted in motor vehicles, aircrafts and watercrafts.

### BACKGROUND OF THE INVENTION

FIG. 1 shows such a simple muffler 110 according to the prior art. The muffler 110 has a housing 112, an inlet pipe 114 and an outlet pipe 116. A respective annular intermediate bottom 122 is provided for holding free pipe ends 118 and 120, respectively. The annular intermediate bottom 122 is fastened to the respective pipe end 118 or 120 and has a push fit with respect to the housing 112. One disadvantage with this known configuration is that if there are temperature-related extensions of the inlet and outlet pipes 114, 116, the intermediate bottoms 122 can get stuck, which is referred to as drawer effect. In addition, in a region between the intermediate bottoms 122 in which no sound-damping material 124 is arranged, hot spots can appear at a housing surface. The volume between the intermediate bottoms 122 can furthermore not be used to damp noises. During manufacturing, two inserts have to be handled which are formed from the respective inlet pipe 114 and outlet pipe 116, respectively, and the associated intermediate bottom 122. Further, the respective push fits require close manufacturing tolerances.

In contrast thereto, the invention provides a muffler which in comparison with the prior art distinguishes itself by an improved mounting of the pipe ends in the housing.

### SUMMARY OF THE INVENTION

According to one example of the invention, in a muffler of the type initially mentioned, improved mounting is achieved by a common intermediate bottom that holds the pipe ends on the housing. In particular, the intermediate bottom extends perpendicularly to a longitudinal axis of the housing and of the inlet and outlet pipes, respectively. In comparison with the prior art, the configuration according to the invention distinguishes itself by a reduced number of components, which represent both a reduction of production cost and of muffler weight. Further, in the muffler according to the invention, there is no gap without sound-damping material. As a result, hot spots cannot occur at the housing. In addition, the muffler volume can be used entirely to damp noises.

The intermediate bottom preferably includes two holding projections that have a portion extending in opposite directions and parallel to the respective longitudinal axis of the inlet and outlet pipes. This leads to a particularly simple configuration for holding the two pipe ends, with the holding projections extending in opposite directions being associated with the two different pipe ends. The holding projections provide a larger support surface towards the pipe. It is further possible to arrange weld seams at a distance from zones subject to bending stresses, in easily accessible regions.

According to an embodiment, the pipe ends rest against the projections associated therewith. They are in particular rigidly connected with, for example welded or soldered to, the projections.

According to an embodiment, the intermediate bottom is firmly connected with the housing. The configuration according to the invention thus completely dispenses with the push fits known from the prior art and the drawbacks related thereto.

The projections are advantageously configured to be resilient in the longitudinal direction of the muffler, which permits a relative motion of the pipe ends to each other or to the housing to accommodate, for example, different thermal expansions. To this end, the projections have in particular a radially extending portion which is fastened on one side, is cantilevered, and can be bent in a resiliently yielding manner. Further advantages of this solution are that jamming, which could occur during thermal expansion, and the undesired noises associated therewith are avoided.

To prevent insulating material from being blown out, the pipe ends can be telescoped into each other in the region of the intermediate bottom to be axially displaceable to each other.

A simple design is achieved if the projections are realized as bent tongues.

The intermediate bottom is preferably a stamped sheet metal component that can be manufactured very cost-effectively.

The projections may be arranged uniformly along a circumference of the pipe ends. This leads to a particularly reliable holding of the pipes, in particular if the projections which point in opposite directions are arranged in an alternating manner to each other.

According to a configuration, the intermediate bottom is annular and serves to hold an inlet pipe and an outlet pipe.

In an alternative configuration of the muffler according to the invention, the muffler includes at least two inlet pipes and outlet pipes associated therewith, the pipe ends of which are held by a common intermediate bottom. This muffler distinguishes itself by a particularly small number of components and thus by a cost-effective manufacturing.

In the case of such a muffler for double-branch or multiple-branch exhaust systems, the intermediate bottom has at least two substantially circular recesses, several holding projections being respectively provided along a circumference of the recesses. Each recess, or the projections surrounding the recesses, serve to hold an inlet pipe and the associated outlet pipe.

These and other features of the present invention can be best understood from the following specification and drawings, the following of which is a brief description.

### BRIEF DESCRIPTION OF THE DRAWINGS

FIG. 1 shows a longitudinal section through a muffler according to the prior art;

FIG. 2 shows a longitudinal section through a muffler according to a first embodiment of the invention;

FIG. 3 shows a cross-section through the muffler of FIG. 2 along the line III-III;

FIG. 4 shows a lateral view of an intermediate bottom used in the muffler of FIG. 2;

FIG. 5 shows a perspective view of the intermediate bottom of FIG. 4;

FIG. 6 shows a sectional view of a muffler according to a second embodiment of the invention;

FIG. 7 shows a section through the muffler of FIG. 6 along the line VII-VII;

FIG. 8 shows a top view onto an intermediate bottom used in the muffler of FIG. 6; and

FIG. 9 shows a perspective view of the intermediate bottom of FIG. 8 along with pipes mounted thereto.

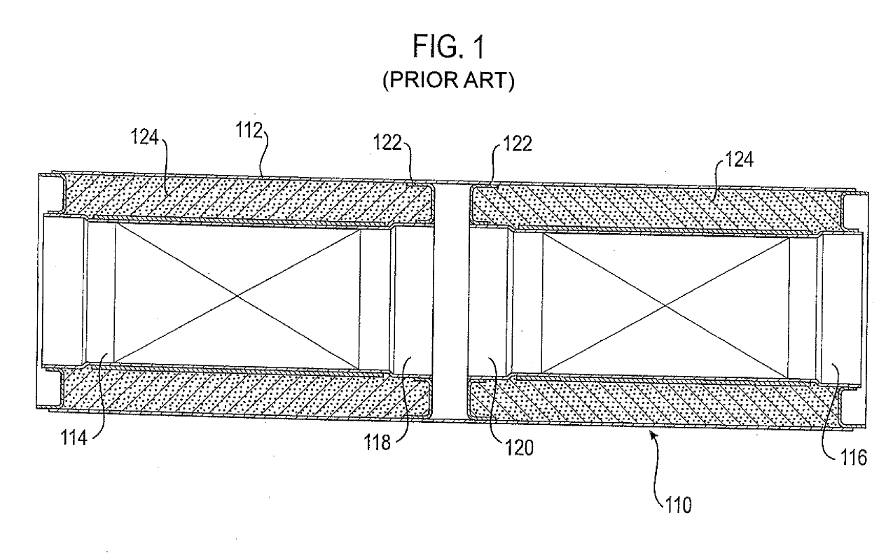

### DETAILED DESCRIPTION OF THE PREFERRED EMBODIMENT

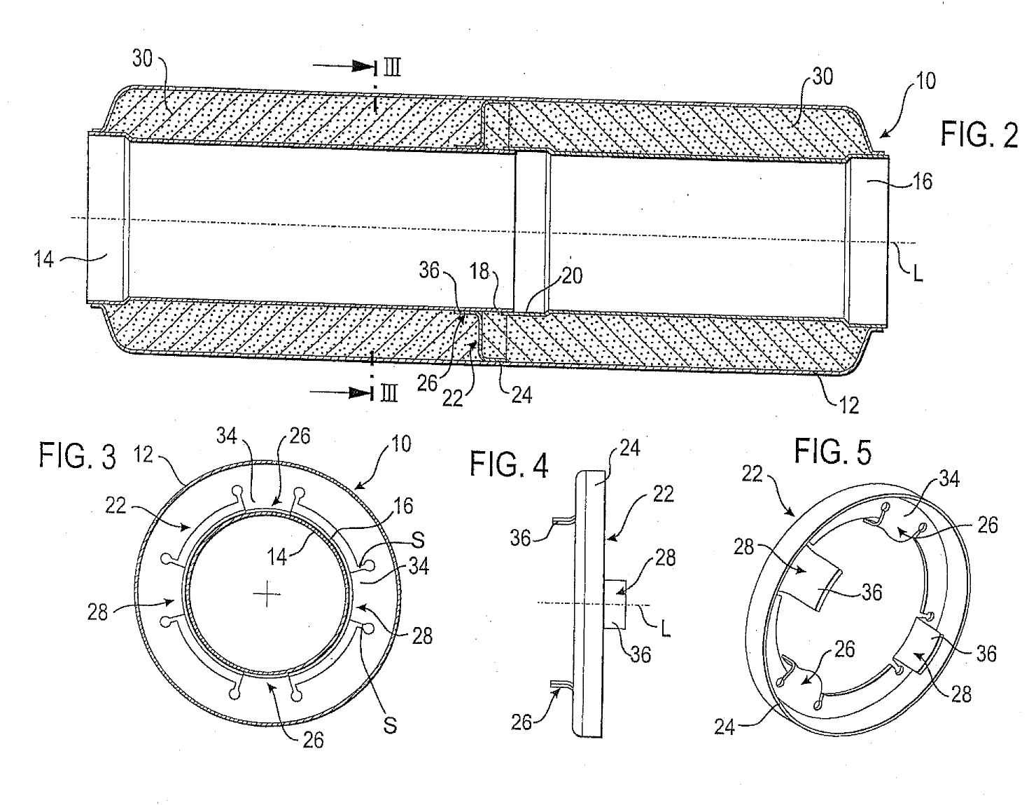

FIGS. 2 and 3 show a muffler 10 according to one example of the invention for an exhaust system of a combustion engine, in the present case of a motor vehicle. The muffler 10 has a housing 12, and an inlet pipe 14 and an outlet pipe 16 that are arranged in the housing. The inlet and outlet sides may of course be exchanged. Both the inlet pipe 14 and the outlet pipe 16 have a pipe end 18 and 20, respectively, arranged inside the housing 12, with the pipe end 18 being inserted into the slightly expanded pipe end 20 in the example shown

For holding the two pipe ends 18, 20, a common annular intermediate bottom 22 is provided which is illustrated separately in FIGS. 4 and 5. The intermediate bottom 22 is for example configured as a stamped sheet metal part and has an encircling reshaped rim 24 that allows the intermediate bottom 22 to rest against the housing 12. In the embodiment shown, the intermediate bottom 22 is firmly connected with the housing 12 in the region of the rim 24, for example by clamping.

As can be seen in the figures, the intermediate bottom 22 has several holding projections 26, 28 in the form of bent tongues that are integrally formed with the intermediate bottom 22 and extend in an alternating manner in opposite directions and parallel to a common longitudinal axis L of the inlet and outlet pipes 14, 16. The holding projections bearing reference numeral 26 point towards the inlet and serve to hold the pipe end 18, whereas the holding projections denoted by 28 extend towards the outlet and hold the pipe end 20.

As is in particular apparent from FIGS. 4 and 5, the holding projections 26, 28 are arranged uniformly along a circumference of the intermediate bottom 22, two respective adjacent holding projections 26, 28 being bent in opposite directions and two respective holding projections 26 and 28, respectively, which point in the same direction facing each other.

As viewed in the axial direction, the holding projections 26, 28 are delimited laterally by radial slots S.

The pipe ends 18, 20 are arranged inside the holding projections 26, 28 (with respect to the common longitudinal axis L) and are rigidly connected therewith, for example, by welding. Each holding projection 26, 28 has a portion 34 which extends radially inwards and is fastened to the intermediate bottom 22 merely on the outside, and an adjoining, axial and cylindrically formed portion 36. Owing to this design, which is in particular apparent from FIGS. 3 and 5, the holding projections 26, 28 can be axially resilient, for which reason the pipe ends 18, 20 are axially displaceable with respect to each other and relative to the housing 12 to permit different thermal expansion processes occurring during operation.

As in the prior art, the inlet and outlet pipes 14 and 16 are also surrounded by a sound-damping material 30 in the configuration according to the invention.

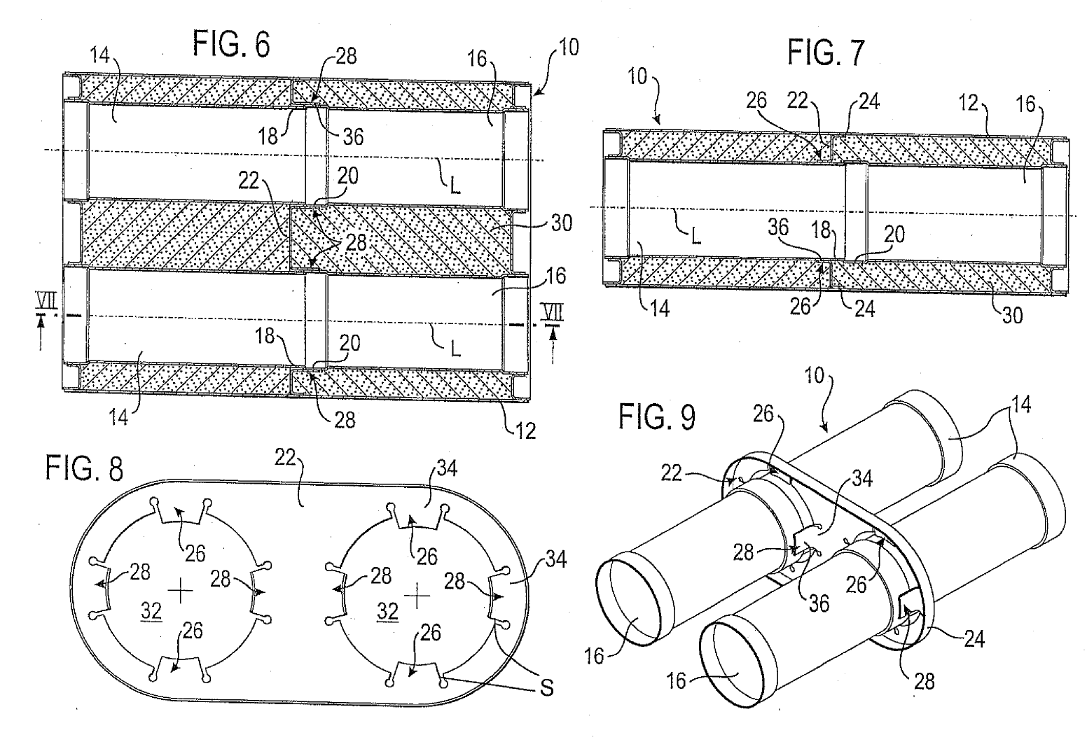

FIGS. 6 and 7 show a muffler 10 according to a second embodiment of the invention, which is used in a two-branch exhaust system (not shown). The same components or components having the same function bear the same reference numerals, and merely the differences to the muffler described so far are discussed below.

The muffler 10 of FIGS. 6 and 7 includes respectively two inlet pipes 14 and two outlet pipes 16 associated therewith, which are arranged in a common housing 12. One single intermediate bottom 22 (cf. also FIGS. 8 and 9) serves to hold all four pipe ends 18, 20, the intermediate bottom 22 having two substantially circular recesses 32 along a circumference of which the holding projections 26, 28 are arranged. Each recess 32 is associated with an inlet pipe 14 (and with the associated outlet pipe 16).

The fact that the muffler according to the invention distinguishes itself by a particularly cost-effective manufacture, a light weight and a simple fabrication applies to both embodiments described. In all embodiments, the axial extent of the angled holding projections 26, 28 is larger than the radial extent (cf. for example FIGS. 3 and 5).

Although an embodiment of this invention has been disclosed, a worker of ordinary skill in this art would recognize that certain modifications would come within the scope of this invention. For that reason, the following claims should be studied to determine the true scope and content of this invention.

What is claimed is:

1. A muffler for an exhaust system of a combustion engine comprising:
a housing;
at least one inlet pipe and at least one outlet pipe each having a pipe end arranged inside the housing; and,
a common intermediate bottom for holding the pipe ends on the housing.

2. The muffler according to claim 1, wherein the common intermediate bottom includes at least two holding projections which have a portion extending in opposite directions and parallel to a respective longitudinal axis of the inlet and outlet pipes.

3. The muffler according to claim 2, wherein the pipe ends rest against the two holding projections associated therewith.

4. The muffler according to claim 2, wherein the pipe ends are rigidly connected with the two holding projections associated therewith.

5. The muffler according to claim 1, wherein the common intermediate bottom is firmly connected with the housing.

6. The muffler according to claim 2, wherein the two holding projections are configured to be resilient.

7. The muffler according to claim 1, wherein in a region of the common intermediate bottom, the pipe ends are pushed into each other to be axially displaceable to each other.

8. The muffler according to claim 2, wherein the two holding projections are configured as bent tongues.

9. The muffler according to claim 1, wherein the common intermediate bottom is configured as a stamped sheet metal component.

10. The muffler according to claim 2, wherein the two holding projections are arranged uniformly along a circumference of the pipe ends.

11. The muffler according to claim 1, wherein the common intermediate bottom is annular.

12. The muffler according to claim ______, including at least two inlet pipes and two outlet pipes associated therewith, the two inlet pipe and two outlet pipes each having pipe ends that are held by a common intermediate bottom.

13. The muffler according to claim 12, wherein the common intermediate bottom has at least two substantially circular recesses, several holding projections being respectively provided along a circumference of the two substantially circular recesses.
